(19) United States
(12) Patent Application Publication
(10) Pub. No.: US 2007/0258848 A1
(43) Pub. Date: Nov. 8, 2007

(54) Metal-Containing, Hydrogen-Storing Material and Method for Its Manufacture

(75) Inventors: Gagik Barkhordarian, Geesthacht (DE); Thomas Klassen, Hamburg (DE); Rudiger Bormann, Rosengarten (DE); Kondo-Francois Aguey-Zin-Sou, Hamburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GKSS-FORSCHUNGSZENTRUM GEESTHACHT GMBH, Geesthacht (DE)

(21) Appl. No.: 10/584,479

(22) PCT Filed: Dec. 7, 2004
(86) PCT No.: PCT/DE04/02679

§ 371 Date: Apr. 9, 2007

(30) Foreign Application Priority Data
Jan. 14, 2004 (DE) 10 2004 002 120.1

(51) Int. Cl. B01J 31/12

(52) U.S. Cl. 420/580; 420/590

(57) ABSTRACT

The invention relates to a metal-containing, hydrogen-storing material that contains a catalyst for hydrating or dehydrating the same. The catalyst is at least one organic compound. The invention also relates to a method for the production of a metal-containing, hydrogen-storing compound, which is characterised in that the metal-containing material and/or the catalyst, which are in the form of an organic compound, is/are subjected to a mechanical grinding process.

The invention relates to a metal-containing, hydrogen-storing material that contains a catalyst for hydrating or dehydrating of the same, and a method for manufacture of a metal-containing, hydrogen-storing material.

A metal-containing material as well as a method of this type are known (DE-A-199 13 714). In the afore-mentioned document the storage of hydrogen by means of metal hydrides was described. It is known that hydrogen in itself is an ideal carrier of energy, since on reconversion into energy only water is formed. Hydrogen itself can be manufactured from water with the help of electrical energy.

By means of this, to some extent, ideal energy carrier that hydrogen represents, it is possible, with electrical energy, at certain places where it is produced, to hydrate, i.e. to load, a hydrogen store, transport it to other places, and, where there is a need for energy, dehydrate, i.e. unload it, and use the released energy for the desired purpose, with water forming again on reconversion. There is, however, still a problem in using hydrogen as an energy carrier, one indeed which has led to a solution that can be used for many purposes, but where, for certain purposes, the solution previously undertaken or, as the case may be, offered, is not yet adequate.

In the storage of hydrogen by means of metal hydrides, as described in the above document, the hydrogen is chemically bound and a corresponding metal hydride is formed. By supplying energy, i.e. by heating the metal, the hydrogen is once again released, so that the reaction is completely reversible. A disadvantage of storing hydrogen by means of a metal hydride is the relatively low reaction speed that results in storage times of several hours. In the case of the generic metal-containing, hydrogen-storing material described above, a catalyst for acceleration of hydration or dehydration was added in the form of a metallic oxide, with an unusually high increase in reaction speed being reached on loading and unloading, this already leading for many cases of application to very useful solutions for normal use. For certain cases of use, even the generic metal-containing, hydrogen-storing material that contains a catalyst in the form of a metal oxide is still not adequate with regard to a reaction speed that is sought or is necessary, as the case may be, in hydration or dehydration, especially since catalysts based on nitrides, oxides and carbides, due to their in part high densities, reduce weight-related storage capacity of the hydrogen-storing material.

It is therefore the task of the present invention to provide a metal-containing material, such as a metal, a metal alloy, an intermetallic phase, and composite materials from metals as well as corresponding hydrides, with which to further clearly improve the reaction time on hydration and dehydration vis-à-vis the corresponding capacity of such types of metals, metal alloys, intermetallic phases, composite materials from metals as well as corresponding hydrides, even when these contain catalysts in the form of metal oxides, so that these are also usable as energy stores for which very rapid energy take-up and/or energy release is important, or extremely rapid hydration and dehydration is possible, as the case may be, where a method for the manufacture of a metal-containing, hydrogen-storing material such as a metal, a metal alloy, an intermetallic phase, as well as a compound material from these materials is to be capable of being performed easily and cost-effectively, such that materials manufactured in this way may be used cost-effectively as hydrogen stores on a large-scale, and with the technically very high reaction speed being ensured in the case of hydration and dehydration.

The task with regard to the metal-containing, hydrogen-storing material is solved by the catalyst comprising at least one organic compound.

The advantage of the organic compounds chosen in accordance with the invention as catalysts is that they can be provided as catalysts much more cost-effectively vis-à-vis metals and it has transpired that, as a result, the reaction kinetics of the metal-containing, hydrogen-storing material are considerably increased and that, already in the case of very small quantities as regards, the actual metal-containing, hydrogen-storing material, an effective increase in the catalytic effect of the organic compound suffices to obtain the very high reaction kinetics desired.

According to a very advantageous embodiment of the invention, the organic compound is a fluid organic compound, which results in a very good distribution of the fluid organic compound being obtained with the actual metal-containing, hydrogen-storing material, such that the manufacturing process of the metal-containing, hydrogen-storing material can be considerably reduced in terms of time.

According to a further advantageous embodiment of the metal-containing material, the organic compound consists of a mix of organic compounds i.e. it is in principle possible for certain application purposes to use different organic compounds in the same metal-containing, hydrogen-storing material as catalysts, with further improvement in the reaction kinetics being obtained in the case of certain quantitatively and qualitatively selectable mixtures.

Equally it is advantageous for certain applications to allow the organic compound of organic composite compounds to remain, and in the case of qualitative and quantitative mixture ratios and mixture components this also leads to an increase in the reaction kinetics for hydration and dehydration of the hydrogen-storing material.

It is quite particularly advantageous to select as organic compound a organometallic compound as catalyst, the compound being able to comprise a metal atom or several metal atoms.

It had previously been expounded that metal in the sense of the genus of hydrogen-storing material in accordance with the invention is to also notionally comprise metal alloys, intermetallic phases, compound materials from metals and corresponding hydrides.

In addition, preferably in principle the metals of the organometallic compound can be Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Cs, Ba, La, Hf, Ta, W, Re, Os, Ir, Pt, Au, Hg, Tl, Pb, Fr, Ra, Ce, Pr, Nd, Pm, Sm, Eu, Gd, Th, Dy, Ho, Er, Tm, Yb, Lu, Th, Pa, U, Np, Pu, Am, Cm, Bk, Cf, Es, Fm, Md, No or Lw.

Finally it is advantageous to give the metal-containing material and/or the catalyst a nanocrystalline structure, with the reaction speed of the hydration or the dehydration, as the case may be, of the metal-containing material being able to be further increased.

Depending on the metal-containing, hydrogen-storing material selected and depending on the organic compound selected as catalyst the organic compound content can be in the region of 0.005 mol % and 50 mol %, preferably between 0.005 mol % and 20 mol %. It has been established that in the case of an organic compound in the form of tetraisopropyl orthotitanate C₁₂H₂₈O₄Ti, the content lies more advantageously, by way of example, in the region of 2 mol %, unusually good reaction kinetics having been obtained in the case of such organometallic compound content.

Along with the organic compound or organometallic compound, as the case may be, as catalyst, the catalyst can additionally comprise a metal carbonate also acting as catalyst.

Here advantage is taken of the circumstance that, compared to pure metals, metal carbonates are brittle, whereby still smaller particle size than previously is obtained in the material according to the invention, as well as still greater homogenous distribution, and, for certain metal-containing, hydrogen-storing materials, this can result in even better reaction kinetics being obtained in comparison to using a pure organic or, as the case may be, organometallic compound as catalyst.

It is, however, also possible, instead of the metal carbonate, to use a compound of a metal with an element of the VIth and/or the VIIth main group of the periodic system of the elements as additional catalyst along with the organic or, as the case may be, organometallic compound, and it is also possible to conceive of application cases where, along with the organic or, as the case may be, organometallic compound, both a metal carbonate and a compound of a metal with an element of the VIth and/or VIIth main group of the periodic system of the elements is used as catalyst. It is also true of the compounds of metals of the VIth and/or VIIth main group of the periodic system of the elements that these are brittle, with the consequence that a small particle size can be realised and a still more homogenous compound obtained in the material according to the invention, and this leads to an increase in the reaction kinetics, for instance vis-à-vis the use of metallic catalysts.

In accordance with an advantageous embodiment of the metal-containing material, for certain application purposes different compounds of a metal with an element from the VIth and/or VIIth main group of the periodic system of the elements or, as the case may be, metal hydroxides, are used in the same metal-containing, hydrogen-storing material as an additional catalyst to the organic or, as the case may be, organometallic compound, with further improvement of the reaction kinetics being obtained in the case of certain quantitatively and qualitatively selectable mixes.

Equally, for certain application cases, it is advantageous to have the compound of a metal with an element of the VIth and/or VIIth main group of the periodic system of the elements, or, as the case may be, the metal hydroxide, consist of composite compounds of metals with elements of the VIth and/or VIIth main group of the periodic system of the elements, or, as the case may be, mixed metal hydroxides, and, in the case of certain qualitative and quantitative mix ratios and mix components, this also leads to an increase in reaction kinetics on hydration and dehydration of the hydrogen-storing material.

Preferably, however, the metal-containing material for certain application cases is selected in such a way, that the metal of the compound of a metal with an element of the VIth and/or VIIth main group of the periodic system of the elements is an elementary metal, or, as the case may be, the metal hydroxide is a hydroxide of an elementary metal.

In accordance with an advantageous development of the invention, the elements of the VIth and/or VIIth main group of the periodic system of the elements are mixed elements of the VIth and/or VIIth main group of the periodic system of the elements, preferably with the metal hydroxide also being able to be a hydroxide of a hydroxide mix.

It is, however, also advantageously possible to select the compound of a metal with an element of the VIth and/or VIIth main group of the periodic system of the elements, or, as the case may be, the metal hydroxide, in such a way that the metals or metal mixes of the compound of a metal with an element of the VIth and/or VIIth main group of the periodic system of the elements, or, as the case may be, of the metal hydroxide, are those of the rare earths.

According to a further advantageous other embodiment of the invention, the catalyst is formed by different compounds of the same metal with an element of the VIth and/or VIIth main group of the periodic system, or, as the case may be, the metal hydroxide is formed by different hydroxides of the same metal, whereby also special areas of application of the hydrogen-storing material can be allowed for, in order to satisfy certain requirements of the desired reaction kinetics.

Finally, it is possible in yet another advantageous embodiment of the invention that the compound of a metal with an element of the VIth and/or VIIth main group of the periodic system of the elements is formed in situ on activated surfaces of the water-storing material by contact with an element of the VIth and/or VIIth main group of the periodic system of the elements, with preferably also the metal hydroxide being formed in situ on activated surfaces of the water-storing material by contact with oxygen and/or hydrogen from the hydrogen-storing material.

Here the surfaces of the hydrogen-storing material can advantageously be, or, as the case may be, become activated chemically and/or mechanically.

The method for manufacture of a metal-containing, hydrogen-storing material as a solution to the above mentioned task, which applies in equal measure to the manufacturing method, is characterised by the metal-containing material and/or the catalyst being subjected to a mechanical grinding process.

Advantageously, a powder is thereby obtained from the metal-containing material and/or the catalyst, such that an optimised reaction surface and a very advantageous defect structure in the total volume of the hydrogen-storing material results and equal distribution of the catalyst therein is made possible.

An advantageous embodiment of the method results from performing the grinding process for different lengths of time depending on the metal-containing materials and/or the catalyst, so that, depending on the length of time, the desired optimum surface of the hydrogen-storing materials and the desired optimum distribution of the catalyst within this can be obtained. Grinding of the catalyst and grinding of the metal-containing material can be selected for differing lengths of time and in such a way, that the degree of pulverisation of the metal-containing material is optimally matched to the desired degree of pulverisation of the catalyst.

Also, according to a further advantageous embodiment of the method, it is possible that the metal-containing material is first subjected to the grinding process and subsequently after addition of the catalyst to this, the grinding process relating to the metal-containing material and the catalyst is continued; but it is also advantageously possible that first the catalyst is subjected to the grinding process and subsequently after addition of the metal-containing material to this, the grinding process relating to the catalyst and the metal-containing material is continued.

The previously described different modifications of the performance of the method are each selected depending on the degree of pulverisation of the catalyst and the degree of pulverisation of the metal-containing material, which are decisive for the optimum possible reaction kinetics depending on the material selected along with the catalyst that is suitably selected for this.

It should however be pointed out that it is in principle possible and is part of the invention that, advantageously, the metal-containing material and the catalyst (from the start) are ground together until the pre-specified degree of pulverisation is reached.

The duration of the grinding process, which again can be selected depending on the hydrogen-storing metal and depending on the selected catalyst, is, as experiments have shown, within the lower region, i.e. already in the region of a few minutes, in order to reach optimum reaction kinetics for a certain selection of the hydrogen-storing material and catalyst. Preferably the duration of this grinding process is thereby in the region of at least one minute, up to a duration of 200 hours.

Therefore, for example, particularly good reaction kinetics are possible already in the case of 20 hours of grinding of certain catalysts according to the invention.

To prevent the metal-containing, hydrogen-storing material and/or catalyst from reacting during the grinding process with the ambient gas in which the grinding process takes place, the grinding process is performed advantageously in an inert gas atmosphere, where the inert gas may preferably be argon, but also, in principle, nitrogen. It should however be pointed out that the method can also in principle be performed in an atmosphere of ambient air, hydrogen or in a vacuum, depending on the selected type of metal (following the above definition) on which the metal-containing material is based and depending on the catalyst selected. Compounds of a metal with an element of the VIth and/or VIIth main group of the periodic system of the elements or the metal hydroxide can also be manufactured in situ by grinding with organic solvents.

If the catalyst is in the form of a liquid organic compound, no grinding is required to obtain homogenous distribution, so the duration of grinding can be considerably reduced overall.

By way of summary, the invention will now be illustrated in detail based on the two figures. Here the figures illustrate the following:

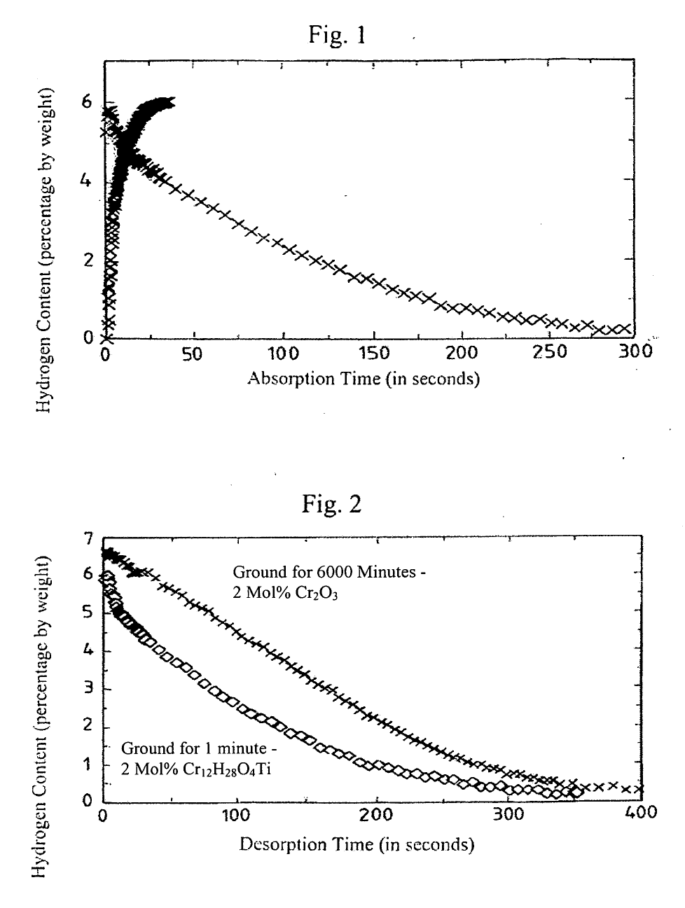

FIG. 1 Progression of the hydrogen absorption and desorption kinetics of magnesium with 2 mol % tetraisopropyl orthotitanate with a grinding duration of 1 minute at a temperature of 300° C. and

FIG. 2 A comparison of the hydrogen desorption kinetics of magnesium with 2 mol % and a grinding duration of 1 minute and 1 mol % Cr₂O₃ with a grinding duration of 100 hours at a temperature of 300° C. in a vacuum.

The metal-containing, hydrogen-storing material is used as a hydrogen-store that can be loaded and unloaded. The physicochemical process of storing the hydrogen is the hydration of the material, and on unloading, it is dehydration. To accelerate the hydration and dehydration, an organic or, as the case may be, a organometallic compound is used as catalyst. The metal-containing, hydrogen-storing material is supplied in a powder-like form to give an extremely large reaction surface. The catalyst content can for instance be 0.005 mol % to 20 mol %, preferably up to 50 mol %.

To have the actual metal-containing, hydrogen-storing material and/or the catalyst available in powder-like form, the catalyst and/or the metal-containing material is/are subjected to a mechanical grinding process.

On the basis of FIGS. 1 and 2 it can be seen that by using the catalyst in accordance with the invention in the form of a organometallic compound, in the case in question of the composite tetraisopropyl orthotitanate C₁₂H₂₈O₄Ti, very much more rapid hydrogen absorption and desorption kinetics are obtained than with the best oxide catalysts used hitherto, as described for instance in DE-A-199 13 714 of the same applicant. There the said metal oxide catalysts are used. Moreover, with the catalyst in accordance with the invention based on organometallic compounds, it is possible to perform hydration of the metal-containing, hydrogen-storing material at temperatures that are considerably lower than when compared to noncatalytic reactions.

1. Metal-containing, hydrogen-storing material that contains a catalyst for hydrating or dehydrating the same, characterised in that the catalyst comprises at least one organic compound.

2. Metal-containing material according to claim 1, characterised in that the organic compound is liquid.

3. Metal-containing material according one or both of claims 1 or 2, characterised in that the organic compound consists of a mix of organic compounds.

4. Metal-containing material according to one or both of claims 1 or 2, characterised in that the organic compound consists of organic composite compounds.

5. Metal-containing material according to one or several of claims 1 to 4, characterised in that the organic compound is a organometallic compound.

6. Metal-containing material according to claim 5, characterised in that the metal of the organometallic compound is Li, Be, B, Na, Mg, Al, Si, K, Ca, Sc, Ti, V, Cr, Mn, Fe, Co, Ni, Cu, Zn, Ga, Ge, Rb, Sr, Y, Zr, Nb, Mo, Tc, Ru, Rh, Pd, Ag, Cd, In, Sn, Cs, Ba, La, Hf, Ta, W, Re, Os, Ir, Pt, Au, Hg, Tl, Pb, Fr, Ra, Ce, Pr, Nd, Pm, Sm, Eu, Gd, Th, Dy, Ho, Er, Tm, Yb, Lu, Th, Pa, U, Np, Pu, Am, Cm, Bk, Cf, Es, Fm, Md, No or Lw.

7. Metal-containing material according to one or several of claims 1 to 6, characterised in that, this displays a nanocrystalline structure.

8. Metal-containing material according to one or several of claims 1 to 7, characterised in that the hydrogen-storing material displays a nanocrystalline structure.

9. Metal-containing material according to one or several of claims 1, 3 to 8, characterised in that the catalyst displays a nanocrystalline structure.

10. Metal-containing material according to one or several of claims 1 to 8, characterised in that the organic compound content is in the region between 0.005 mol % and 20 mol %, preferably in the region up to 50 mol %.

11. Metal-containing material according to claim 10, characterised in that the organic compound content is in the region of 2 mol %.

12. Metal-containing material according to one or several of claims 1 to 11, characterised in that the catalyst comprises additionally a metal carbonate.

13. Metal-containing material according to one or several of claims 1 to 12, characterised in that the catalyst comprises additionally a compound of a metal with an element of the VIth and/or VIIth main group of the periodic system of the elements.

14. Metal-containing material according to one or several of claims 1 to 13, characterised in that the catalyst additionally comprises a metal hydroxide.

15. Method for the manufacture of a metal-containing material according to one or several of claims 1 to 14, characterised in that the metal-containing material and/or the catalyst is or, as the case may be, are subject to a mechanical grinding process.

16. Method according to claim 15, characterised in that the grinding process is performed for a different length of time depending on the metal-containing catalyst.

17. Method according to one or both of claims 15 or 16, characterised in that the metal-containing material is first subjected to the grinding process and subsequently, after addition of the catalyst to this, the grinding process in regard to the metal-containing material and the catalyst is continued.

18. Method according to one or both of claims 15 or 16, characterised in that the catalyst is first subjected to the grinding process and subsequently, after addition of the metal-containing material to this, the grinding process in regard to the catalyst and the metal-containing material is continued.

19. Method according to one or both of claims 15 or 16, characterised in that the metal-containing material and the catalyst are each separately subjected to a grinding process and subsequently mixed.

20. Method according to one or both of claims 15 or 16, characterised in that the metal-containing material and the catalyst are ground together.

21. Method according to one or several of claims 15 to 20, characterised in that the duration of the grinding process is in the region of 0 to 200 hours, preferably in the region of 1 minute to 200 hours.

22. Method according to claim 21, characterised in that the duration of the grinding process is in the region of 20 to 100 hours.

23. Method according to one or several of claims 15 to 22, characterised in that the grinding process is performed in an inert gas atmosphere.

24. Method according to claim 23, characterised in that the inert gas is argon.

25. Method according to one or several of claims 15 to 23, characterised in that the grinding process takes place with the addition of an organic solvent.

26. Method according to one or several of claims 15 to 21, 25, characterised in that the grinding process is performed in an atmosphere containing CO and/or CO₂.
